(19) United States
(12) Patent Application Publication
(10) Pub. No.: US 2008/0315940 A1
(43) Pub. Date: Dec. 25, 2008

(54) Mixing device for plural digital data having different sampling rates

(75) Inventor: Koji Yamamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/155,993

(22) Filed: Jun. 12, 2008

(30) Foreign Application Priority Data
Jun. 19, 2007 (JP) 2007-161219

(51) Int. Cl. G06G 7/12

(52) U.S. Cl. 327/355

(57) ABSTRACT

A method of mixing a first digital data having a first sampling rate and a second digital data having a second sampling rate includes converting the second digital data, by using a first coefficient obtained by multiplying a sampling coefficient with a volume coefficient for the second digital data, to produce a converted second digital data which has the same sampling coefficient as the first digital data, converting the first digital data, by using a volume coefficient for the first digital data, to produce a converted first digital data and mixing the converted second digital with the converted first digital data.

### BACKGROUND OF THE INVENTION

1. Field of the Invention

The present invention relates to a technique for mixing a plurality of digital data, specifically a plurality of digital data whose sampling rates are different.

2. Description of Related Art

Digital audio data are often recorded into different kinds of recording media such as a CD (Compact Disc), an MD (Mini Disc), a DAT (Digital Audio Tape), and a DVD (Digital Versatile Disc) in various recording methods. The sampling rates of audio data may be different depending on recording media and recording methods.

There are generally two methods for mixing a plurality of digital audio data whose sampling rates are different. The first method is to: perform D/A conversion to convert the plurality of digital audio data into analog signals and mix the signals; and then perform sampling on the mixed analog signals by D/A conversion to convert the signals back into digital audio data. The second method is to perform sampling rate conversion such that the sampling rates of the plurality of digital audio data become the same, and then to mix the digital data as they are by adding thereto audio data after the sampling rate conversion by the sample.

The first method causes a problem that the quality of an original audio data source is deteriorated due to the mixing since the audio data are once converted back into analog and are then mixed.

Proposed are various methods for a process of converting the sampling rates of audio data for mixing the audio data while keeping the digital data as they are, as is similar to the second method.

For example, Patent Document 1 discloses a method for mixing two digital data sets A and B whose sampling rates are different. In this method, the sampling rate of the digital data B is converted into the sampling rate of the digital data A by performing the interpolation processing on the digital data B whose sampling rate is lower (refer to [0015] in Patent Document 1). Specifically, in this interpolation processing, in a coordinate system where the horizontal axis shows time and the vertical axis shows values of sampling data, three samples (Y0, Y1, Y2) of the digital data B, which are continuous in terms of time, are connected with straight lines between Y2 and Y1, and Y2 and Y0, respectively. Then, a value of one interpolation sample or more to be interpolated between the sampling data Y1 and Y2 are obtained based on the slopes of the two straight lines and the scale factor of the sampling rate. The process is a product-sum operation where the values of the samples Y0, Y1, and Y2 are multiplied by interpolation coefficients corresponding to the respective samples, and the interpolation coefficients depend on the sampling rate scale factor.

Furthermore, Patent Document 2 discloses a method for converting sampling rates by taking a weighted moving average by use of an FIR (Finite Impulse Response) filter after inserting values 0 into digital data whose sampling rate is converted, with frequency corresponding to the scale factor of the sampling rate conversion. FIG. 13 is FIG. 6 in Patent Document 2 and shows a digital filter which processes, based on this method, the input data of two channels (which correspond to two input data whose sampling rates are different) included in the time-division multiplexed input data. The digital filter has a data storage 70, a multiplier 20, an output coefficient storage 31 which stores an output coefficient for converting the level of input data, a filter coefficient storage 30 which stores a plurality of filter coefficients for performing the filter process, a pan coefficient storage 32 which stores a pan coefficient for the panning process to mix the two input data in a specified ratio, a cumulative adder 40, and data output units 51 and 52.

The data storage 70 stores a plurality of newest samples and the values 0 inserted between the plurality of samples, for each of input data. For convenience of explanation, the plurality of samples and the values 0 are hereinafter referred to as samples for conversion.

A digital filter shown in FIG. 13 converts a sampling rate by firstly performing the following process on one of the input data.

A selector 78 in the data storage 70 sequentially outputs the above samples for conversion of the input data set to the multiplier 20. Then, the multiplier 20 multiplies the sample for conversion outputted from the selector 78 by an output coefficient stored in the output coefficient storage 31, and outputs the multiplication result to the cumulative adder 40. The cumulative adder 40 holds the multiplication result of the multiplier 20 as well as provides feedback to the data storage 70. With this process, each conversion sample whose level has been converted is stored in the data storage 70.

Next, the selector 78 sequentially outputs, to the multiplier 20, each conversion sample whose level has been converted, and the multiplier 20 multiplies the output of the selector 78 by the corresponding filter coefficient stored in the filter coefficient storage 30, and outputs the multiplication result to the cumulative adder 40. The cumulative adder 40 cumulates the multiplication results of the multiplier 20, and then provides feedback to the data storage 70. With this process, the sample value whose sampling rate has been converted is stored in the data storage 70.

The same process as above is performed on the other data set out of the two input data, and the sample value of the input data set whose level is changed to convert the sampling rate is stored in the data storage 70.

Then, the selector 78 sequentially reads the above sample values of the two data sets from the data storage 70 to output the values to the multiplier 20. Then, the multiplier 20 multiplies the output of the selector 78 by the pan coefficient stored in the pan coefficient storage 32 to output the result to the cumulative adder 40. A cumulative adder 40 adds the sample values multiplied by the respective pan coefficients, and the data output unit 51 outputs the addition result of the cumulative adder 150.

The method of Patent Document 2 can mix digital data while keeping the digital form. In addition, the multiplier 20 and the cumulative adder 40 can be commonly used to each of the input data sets. Therefore, the circuit size is controlled to a certain extent.
[Patent Document 1] Japanese Patent Laid Open Application No. Hei 11-213558
[Patent Document 2] Japanese Patent Laid Open Application No. 2003-264451
[Patent Document 3] Japanese Patent Laid Open Application No. 2004-266824

In recent years, the higher density of a recording medium, the higher rate of data communication, the improvement of a data compression technology, and the like have led to multichannel and higher sampling rate of digital data such as digital audio data. As a result, the processing load of a device to process these data and the circuit size are increasing, and are expected to further increase still in the future. In these days when each company competes fiercely for reduction in cost, it is desired to further reduce the processing load and further control the circuit size.

### SUMMARY OF THE INVENTION

One exemplary aspect of the present invention is a mixing device which mixes a digital set A having a first sampling rate and a digital data B having a second sampling rate which is lower than the first sampling rate. The mixing device includes a data storage, a coefficient storage, an operation control selector, a multiplier, a cumulative adder, and a controller.

The controller generates an insertion signal to provide it to the data storage.

The data storage stores, while shifting, a plurality of newest samples in the digital data B and insertion values inserted between the plurality of samples, as the samples for conversion, in response to the insertion signal from the controller, the number of the insertion values being in accordance with the ratio of the first and second sampling rates.

The coefficient storage stores a plurality of combined coefficients obtained by multiplying a plurality of conversion coefficients by a B volume coefficient for adjusting the volume of the digital data B. The plurality of conversion coefficients are for obtaining samples in the digital data B by the product-sum operation with a plurality of samples for conversion stored in the data storage after the sampling rate is converted to the first sampling rate.

The operation control selector is for outputting a sample/coefficient pair consisting of one sample for conversion among the plurality of samples conversion stored in the data storage and one combined coefficient, which corresponds to the one sample, among the plurality of combined coefficients stored in the coefficient storage, and performs a first output process to sequentially output sample/coefficient pairs of a number according to the degree of the above product-sum operation.

The multiplier multiplies the sample/coefficient pair outputted from the operation control selector, and the cumulative adder cumulates the multiplication results of the multiplier.

Another exemplary aspect of the present invention is also a mixing device which mixes a digital set A having a first sampling rate and a digital data B having a second sampling rate which is lower than the first sampling rate. The mixing device includes a data storage, a coefficient storage, an operation control selector, a multiplier, a cumulative adder, and a controller.

The controller generates a control signal which shows any one of “the output of an original sample” and “the generation of an interpolation sample,” and outputs the control signal to the operation control selector.

The data storage stores, while shifting, a plurality of newest samples in the digital data B.

The operation control selector stores a plurality of combined coefficients and a B volume coefficient for adjusting the volume of the digital data B. The plurality of combined coefficients is obtained by multiplying a plurality of interpolation coefficients by the B volume coefficient. The plurality of interpolation coefficients are determined in accordance with the ratio of the first and second sampling rates and the plurality of samples stored in the data storage. By performing product-sum operation on the plurality of interpolation coefficients and the plurality of samples, interpolation samples designed to be inserted between the above plurality of samples can be obtained. The interpolation samples are for converting the sampling rate of the digital data B into the first sampling rate.

While outputting a specified sample among the plurality of samples stored in the data storage and the B volume coefficient stored in the coefficient storage when the control signal given by the controller shows “the output of an original sample”, the operation control selector sequentially outputs one sample after another from the plurality of samples together with one combined coefficient, which corresponds to the one sample, among the plurality of combined coefficients stored in the coefficient storage when the control signal given by the controller shows “the generation of an interpolation sample”.

The multiplier multiplies a sample/coefficient pair outputted from the operation control selector, and the cumulative adder cumulates the multiplication results of the multiplier.

Note that those which represent each of the above aspects of the mixing device as a method, and which represent the method as a program, a system and the like to cause a computer to execute are also effective as aspects of the present invention.

With a technology according to the present invention, it is possible to aim reduction in processing load and control over a circuit size, when mixing a plurality of digital data whose sampling rates are different.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a view showing a mixing device according to a first exemplary embodiment of the present invention;

FIG. 2 is a view for explaining the contents of the control of a controller in the mixing device shown in FIG. 1;

FIG. 3 is a flow chart showing the processing of the mixing device shown in FIG. 1 (Number 1);

FIG. 4 is a flow chart showing the processing of the mixing device shown in FIG. 1 (Number 2);

FIG. 5 is a flow chart showing the processing of the mixing device shown in FIG. 1 (Number 3);

FIG. 6 is a view showing a mixing device according to a second exemplary embodiment of the present invention;

FIG. 7 is a view for explaining the contents of the control of a controller in the mixing device shown in FIG. 6;

FIG. 8 is a flow chart showing the processing of the mixing device shown in FIG. 6 (Number 1);

FIG. 9 is a flow chart showing the processing of the mixing device shown in FIG. 6 (Number 2);

FIG. 10 is a view comparing positions of samples in data before and after sampling rate conversion when the scale factor of a sampling rate is an integral multiple;

FIG. 11 is a view comparing positions of samples in the data before and after the sampling rate conversion when the scale factor of a sampling rate is not an integral multiple;

FIG. 12 is a view showing a mixing device according to another embodiment of the present invention; and

FIG. 13 is a view for explaining a related art.

### DETAILED DESCRIPTION OF THE EXEMPLARY EMBODIMENTS

Before describing specific embodiments of the present invention, descriptions will firstly be given of the principle of the present invention taking an example of digital audio data.

As described above, there is a method for filtering such as the FIR filtering by inserting 0s of a number in accordance with the scale factor of the sampling rate conversion between samples of digital audio data upon converting the sampling rate of the digital audio data. The FIR filtering is generally the product-sum operation shown by the following equation (1). Note that an “input signal value” shown as X in the equation (1) indicates a signal value provided for the FIR filtering and is a sample value of the audio data or an inserted value 0.

Y_{K}=h₀X_{K}+h₁X_{K-1}+ . . . hₙX_{K-n} (1)

where

Y: output signal value (signal value after sampling rate conversion)

X: input signal value

h: conversion coefficient

n: degree

As can be seen from the equation (1), according to the FIR filtering, the output signal value Y_{K} in the time _{K} is a weighted average value of the current and the past input signal values X_{K}, X_{K-1}, . . . X_{K-n}.

Moreover, when a plurality of audio data whose sampling rates are different are mixed while keeping their digital forms, the sampling rate of each of the audio data is made the same for mixing. Upon the mixing, the volume adjustment process is performed for the volume adjustment. In this process, a sample of the audio data is multiplied by a coefficient (volume coefficient) of the volume adjustment set for the audio data. The volume adjustment process can be represented by the following equation (2).

X′_{K}=α×X_{K} (2)

where

X′: input signal value after volume adjustment

X: input signal value before volume adjustment

α: volume coefficient

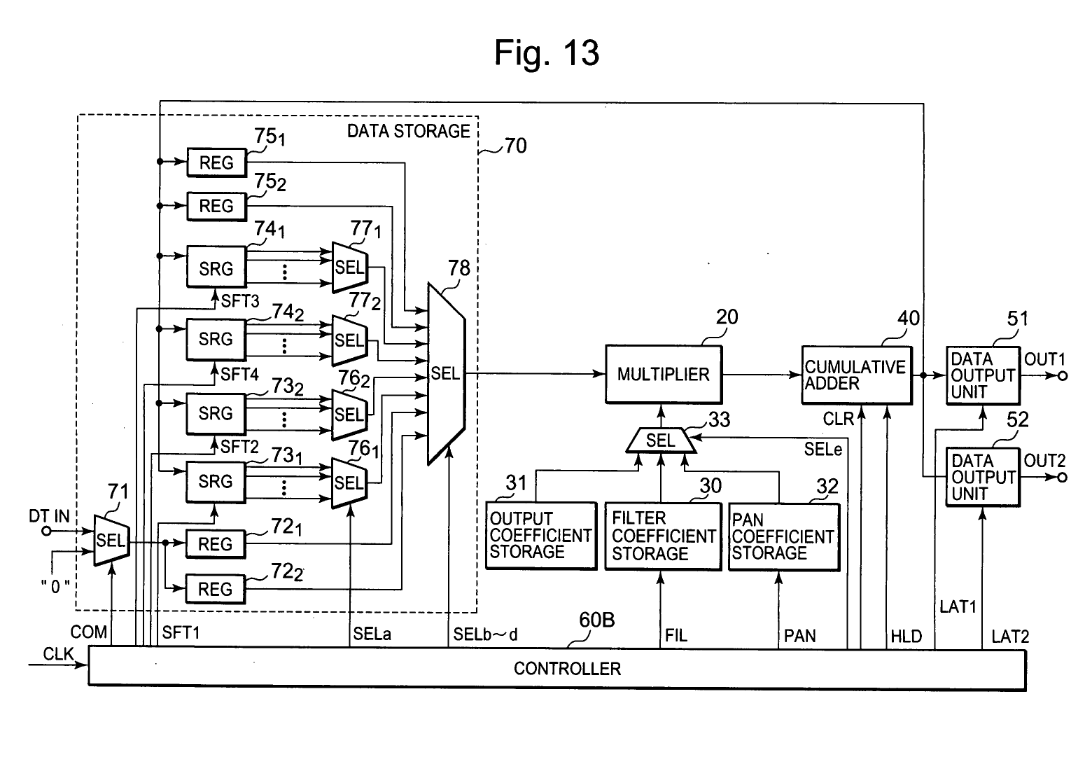

Note that the volume coefficient corresponds to one obtained by multiplying an output coefficient stored in the output coefficient storage 31 in the digital filter shown in FIG. 13 by a pan coefficient stored in the pan coefficient storage 32.

The following equation (3) can be obtained if X′_{K} in the equation (2) is substituted into the equation (1) as the input signal value X_{K}.

Z_{K}=αh₀X_{K}+αh₁X_{K-1}+ . . . αhₙX_{K-n} (3)

where

Z: output signal value

X: input signal value

h: FIR filter coefficient

α: volume coefficient

The output signal value Z in the equation (3) is a signal value after the sample conversion and the volume adjustment. In other words, if a coefficient of the FIR filtering is set to “FIR filter coefficient×volume coefficient”, the sampling rate conversion and the volume adjustment can be simultaneously performed by the FIR filtering.

Next, descriptions will be given of a case of a method for converting a sampling rate by performing the interpolation process on digital audio data without using the FIR filter.

In this method, upon interpolation process, interpolation samples to be inserted in the predetermined positions between a plurality of samples are obtained by use of the plurality of samples in the digital audio data. Among various methods of the interpolation processes for obtaining the interpolation data, there is a method for performing product-sum operation between a plurality of samples (the three samples in the example of Patent Document 1) and a plurality of interpolation coefficients, as disclosed in Patent Document 1, for example. The method can be expressed by the following equation (4). Note that an “input signal value” in the equation (4) indicates a signal value provided for the process of obtaining the interpolation data, and is an original sample value of the audio data.

Y_{K}=β₀X_{K}+β₁X_{K-1} . . . βₘX_{K-m} (4)

where

Y: interpolation sample value

X: input signal value

β: interpolation coefficient

m: number of samples used for interpolation

Provided the volume coefficient is a similarly, interpolation samples in which the volume has been adjusted can be obtained by an operation shown in the following equation (5).

Z=αβ₀X_{K}+αβ₁X_{K-1}+ . . . αβₘX_{K-m} (5)

where

Z: output signal value

X: input signal value

α: volume coefficient

β: interpolation coefficient

m: number of samples used for interpolation

The output signal value Z in the equation (3) is a signal value after the sample conversion and the volume adjustment. In other words, the interpolation process and the volume adjustment can be simultaneously performed by performing the interpolation process while setting the coefficient of the interpolation process to “interpolation coefficient×volume coefficient”.

In other words, by performing the product-sum operation using the combined coefficient obtained by multiplying the coefficient of the product-sum operation for the sampling rate conversion, by the volume conversion, the sampling rate conversion and the volume adjustment can be simultaneously performed.

Descriptions will hereinafter be given of embodiments which embody the above principle.

### First Embodiment

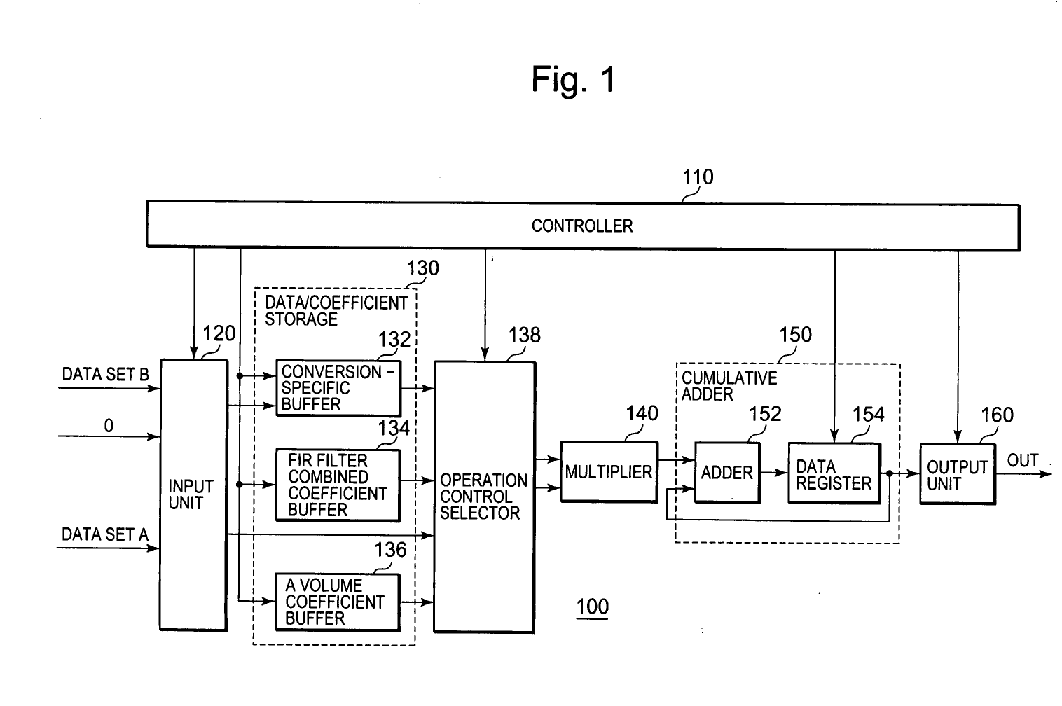

FIG. 1 shows a mixing device 100 according to a first embodiment of the present invention. The mixing device 100 is for mixing a plurality of audio data. As an example, the number of audio data to be the target of the process of the mixing device 100 is two data sets A and B, and the sampling rate of the digital data A is higher than that of the digital data B. In addition, the mixing device 100 is for converting the sampling rate of the digital data B into that of the digital data A, and mixing the digital data A and the digital data B sampling rate of which has been converted. Upon converting the sampling rate of the digital data B, the mixing device 100 uses a method for performing the FIR filtering by inserting a value 0.

As shown in FIG. 1, the mixing device 100 includes a controller 110, an input unit 120, a data/coefficient storage 130, an operation control selector 138, a multiplier 140, a cumulative adder 150, and an output unit 160. The data/coefficient storage 130 has a conversion-specific data buffer 132, an FIR filter combined coefficient buffer 134, and an A volume coefficient buffer 136. The cumulative adder 150 has an adder 152 and a data register 154. Note that in FIG. 1 each element described as a functional block for performing various processes can be configured of a CPU (Central Processing Unit), a memory, and other LSIs in terms of hardware, and can be implemented with a program loaded into memory and the like in terms of software. Therefore, it is understood by those skilled in the art that these functional blocks can be implemented in various forms of hardware only, software only, and combination of these, and it is not limited to any one of them.

The input unit 120 inputs the data sets A and B being the digital audio data and a value 0 to be the insertion value in accordance with the control of the controller 110.

The input unit 120 inputs the samples of the digital data A or B into the data/coefficient storage 130 while controlled by the controller 110. Furthermore, the input unit 120 inputs the insertion value inserted between the samples of the digital data B, here the value 0, into the data/coefficient storage 130 in response to the insertion signal (unillustrated) from the controller 110.

In the data/coefficient storage 130, the conversion-specific data buffer 132 stores, while shifting, data for the sampling rate conversion of the digital data B. In the present embodiment, the sampling rate conversion of the digital data B is performed by inserting, between the samples of digital data B, the value 0 of a number according to the scale factor of the sampling rate conversion (the ratio of the sampling rates of the data sets A and B), and then by performing the FIR filtering. Accordingly, the data for sampling rate conversion of the digital data B (hereinafter, also referred to as the sample for conversion) are a plurality of newest samples of the digital data B, and the value 0 inserted between these samples.

Moreover, the FIR filter combined coefficient buffer 134 and the A volume coefficient buffer 136 store an FIR filter combined coefficient and a coefficient for the volume adjustment of the digital data A (hereinafter, also referred to as the A volume coefficient), respectively. The FIR filter combined coefficient is obtained by multiplying the FIR filter coefficient by a coefficient for the volume adjustment of the digital data B (hereinafter, referred to as the B volume coefficient).

The operation control selector 138, which is a selector with four inputs and two outputs, outputs any one of samples for conversion stored in the conversion-specific data buffer 132 and the samples of the digital data A inputted from the input unit 120, and any one of the coefficients stored in the FIR filter combined coefficient buffer 134 and the coefficients stored in the A volume coefficient buffer 136.

The multiplier 140 multiplies the sample/coefficient pair outputted from the operation control selector 138 together.

The cumulative adder 150 has the adder 152 and the data register 154. The data register 154 outputs the output of the adder 152 to the output unit 160 as well as provides feedback to the adder 152. The adder 152 adds up the output of the multiplier 140 and the feedback from the data register 154, and outputs the resultant data to the data register 154.

The output unit 160 outputs the result of the cumulative addition from the data register 154 in accordance with the control of the controller 110.

The controller 110 is configured of a microprocessor, for example, and controls each of the above functional blocks and sets a coefficient in each type of coefficient buffers. Here, descriptions will be given of the control of the controller 110 over the operation control selector 138 and the output unit 160.

The controller 110 has two modes of control, “sampling rate conversion” and “mixing.” Depending on the control mode, the controller 110 generates and outputs different control signals, and causes the operation control selector 138 and the output unit 160 to perform different processes. The “sampling rate conversion” mode is a mode for converting the sampling rate of the digital data B, whereas the “mixing” mode is a mode for mixing samples of the digital data A and the digital data B after the sampling rate conversion.

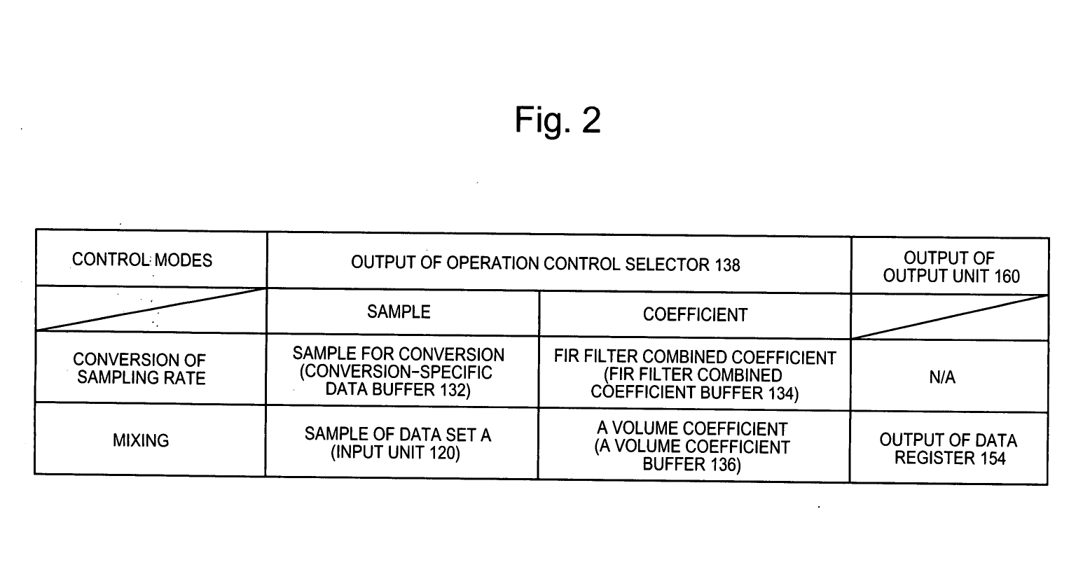

FIG. 2 shows processes, for each of the two control modes, performed by the operation control selector 138 and the output unit 160 in accordance with the control of the controller 110.

When in the “sampling rate conversion” mode, the operation control selector 138 outputs samples for conversion stored in the conversion-specific data buffer 132 in terms of samples, and outputs FIR filter combined coefficients stored in the FIR filter combined coefficient buffer 134 in terms of coefficients. Additionally, in this case, the output unit 160 does not output the cumulative addition result from the data register 154.

When in the “mixing” mode, the operation control selector 138 outputs the samples of the digital data A inputted from the input unit 120 in terms of samples, and outputs A volume coefficients stored in the A volume coefficient buffer 136 in terms of coefficients. Additionally, in this case, the output unit 160 outputs data from the data register 154 as the mixing result.

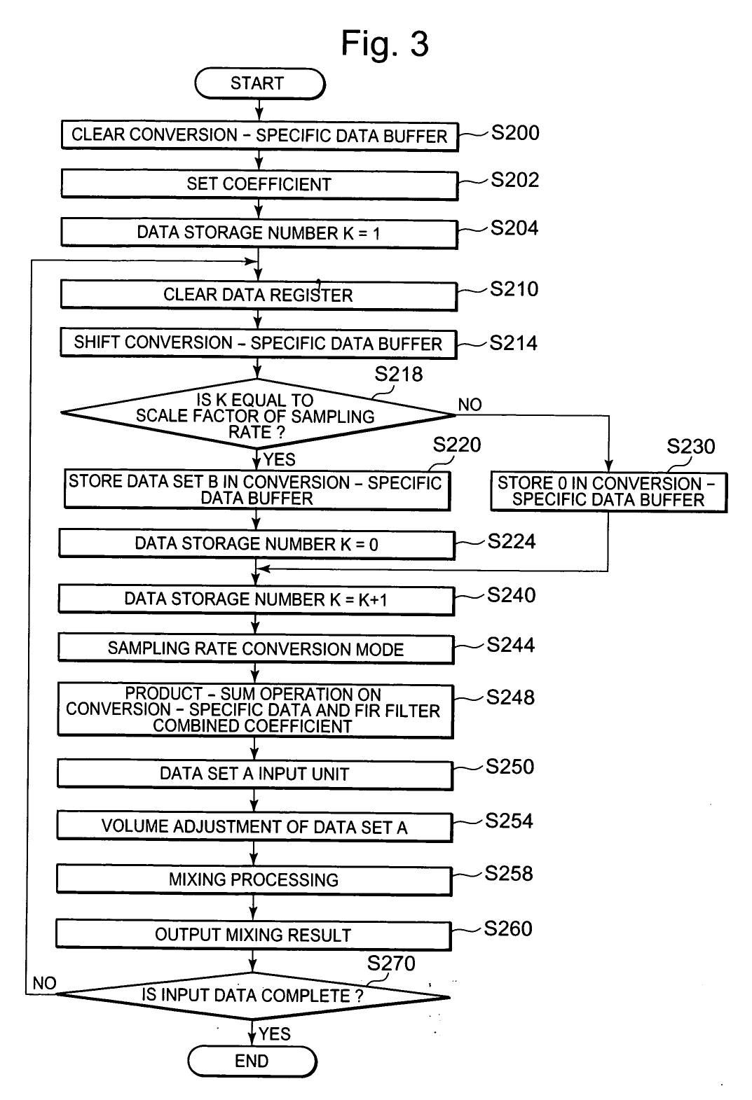

With reference to FIGS. 3, 4, and 5, detailed descriptions will be given of processes of the mixing device 100. To make it easier to understand, the descriptions will firstly be given of a case where the sampling rate of the digital data A is an integral multiple of the sampling rate of the digital data B. Note that, in the following descriptions, the ratio of the sampling rates of the data sets A and B will be referred to as the “scale factor of the sampling rate”.

FIG. 3 is a flow chart showing the processing of the mixing device 100 in a case where the sampling rate of the digital data A is an integral multiple of the sampling rate of the digital data B.

Upon the start of the processing, the controller 110 clears the conversion-specific data buffer 132 (S200).

Next, the controller 110 sets the coefficients of the FIR filter combined coefficient buffer 134 and the A volume coefficient buffer 136 in the data/coefficient storage 130 (S202). Specifically, the controller 110 sets, in the FIR filter combined coefficient buffer 134, a value (the FIR filter combined coefficient) obtained by multiplying the FIR filter coefficient for converting the sampling rate of the digital data B by the coefficient for the volume adjustment of the digital data B, and sets, in the A volume coefficient buffer 136, the coefficient for the volume adjustment of the digital data A.

Subsequently, the controller 110 sets, to 1, a counter value (hereinafter, referred to as the number of times K of storage) for counting the number of times data are stored in the conversion-specific data buffer 132, and clears the data register 154 in the cumulative adder 150 (S204, S210).

Then, the controller 110 causes the conversion-specific data buffer 132 to shift data by one sample (S214).

Here, when the number of times k of data storage in the conversion-specific data buffer 132 is equal to the scale factor of the sampling rate (S218: Yes), the controller 110 causes the input unit 120 to store the samples of the digital data B in the conversion-specific data buffer 132 as well as resets the number of times k of storage to 0 (S218: Yes, S220, S224). On the other hand, when the number of times of data storage in the conversion-specific data buffer 132 is not equal to the scale factor of the sampling rate, the controller 110 causes the input unit 120 to store the value 0 in the conversion-specific data buffer 132 (S218: No, S230).

Next, the controller 110 increments the number of times k of data storage as well as switches the control mode to the “sampling rate conversion” mode (S240, S244).

With this, the operation control selector 138 outputs, to the multiplier 140, data of the first one sample among the data for conversion stored in the conversion-specific data buffer 132 and the first combined coefficient among the FIR filter combined coefficients stored in the FIR filter combined coefficient buffer 134. The multiplier 140 multiplies the data for conversion by the coefficient, both being outputted from the operation control selector 138, and outputs the multiplication result to the adder 152. The adder 152 adds the output of the multiplier 140 to the previous addition result of the adder 152 given as feedback from the data register 154, and outputs the addition result to the data register 154. The data register 154 outputs the current addition result from the adder 152, to the output unit 160 as well as provides feedback to the adder 152. In addition, the controller 110 causes the conversion-specific data buffer 132 to shift and causes the FIR filter combined coefficient buffer 134 to output the next combined coefficient, both being performed by the degree of the FIR filter. As a result, the product-sum operation is performed on the data for conversion and the FIR filter combined coefficient, and a data value (one sample) after the sampling rate conversion of the digital data B is stored in the data register 154 (S248).

Then, the controller 110 switches the control mode to “mixing” (S250). With this, the samples of the digital data A is inputted from the input unit 120, and the operation control selector 138 outputs the sample of the digital data A inputted by the input unit 120 and the A volume coefficient stored in the A volume coefficient buffer 136. Then, the multiplier 140 multiplies the sample of the digital data A by the A volume coefficient, and as a result, the volume of the sample of the digital data A is adjusted (S254).

At this point, what is provided as feedback from the data register 154 to the adder 152 is the sample value of the digital data B after the sampling rate conversion. The adder 152 adds the sample value of the digital data A after the volume adjustment from the multiplier 140 to the feedback from the data register 154, thereby mixing the samples of the data sets A and B (S258).

Moreover, since the control mode is “mixing,” the output unit 160 outputs the output of the data register 154, that is, the mixing result, to the outside.

The above processes from Step S210 onward are performed until the data inputted to the input unit 120 are complete.

In this manner, according to the mixing device 100 of the present invention, it is possible to simultaneously convert the sampling rate of the digital data B and adjust the volume of the digital data B, by using, as a coefficient of the FIR filtering, the FIR filter combined coefficient obtained by multiplying the FIR filter coefficient by the coefficient for the volume adjustment of the digital data B upon the sampling rate conversion of the digital data B. The technology described in Patent Document 2 separately performs the sampling rate conversion and the volume adjustment, of the digital data B, so that the volume adjustment process at 48000 times/second is required when the sampling rate of the digital data A is 48 KHz. With the mixing device 100 of the present embodiment, the number of the product-sum operations in the FIR filtering for the sampling rate conversion is equal to the degree of the FIR filter, like the technology disclosed in Patent Document 2, but there is no need to perform the volume adjustment at 48000 times/second so that the operation load on the device is small.

Furthermore, the technology disclosed in Patent Document 2 performs the sampling rate conversion after the volume adjustment. Accordingly, the technique is configured to provide a sample value after the volume adjustment, as feedback, to an input register (corresponding to the conversion-specific data buffer 132 in the present embodiment) of the digital data B. Therefore, a circuit for the feedback is further required. Moreover, a buffer storing the volume coefficient of the digital data B is also needed besides a buffer storing the FIR filter coefficient. In contrast, the mixing device 100 of the present embodiment does not require a circuit and a buffer like above so that it is effective in controlling a circuit size.

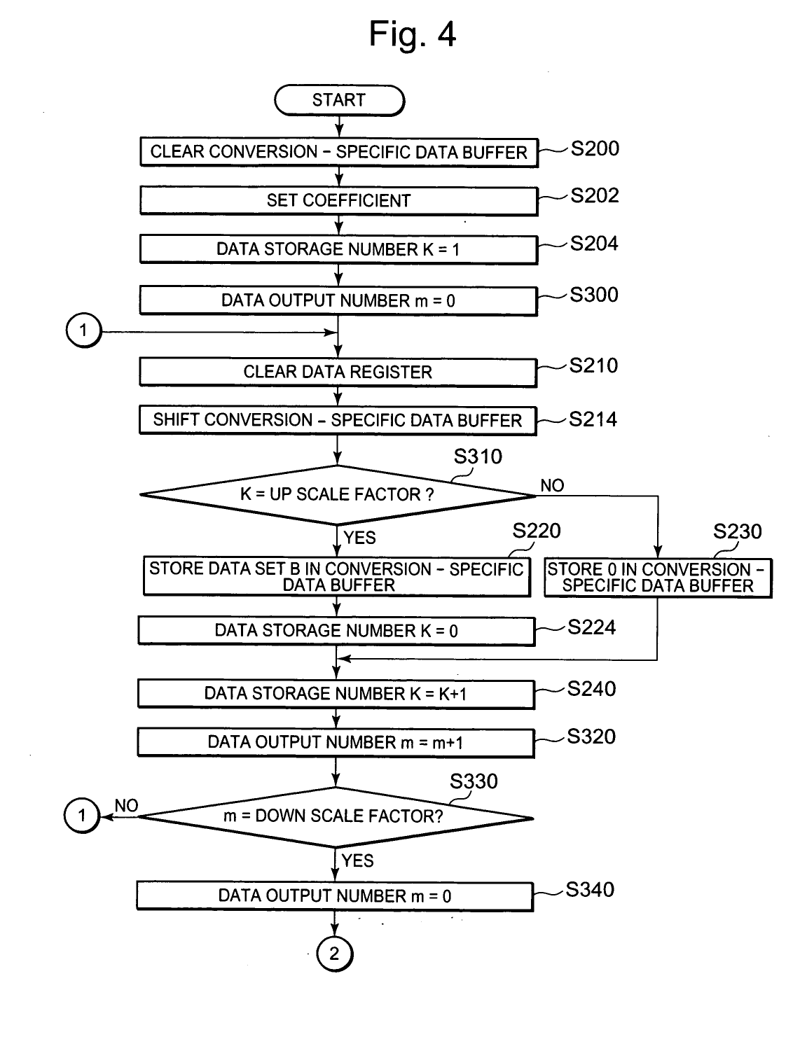

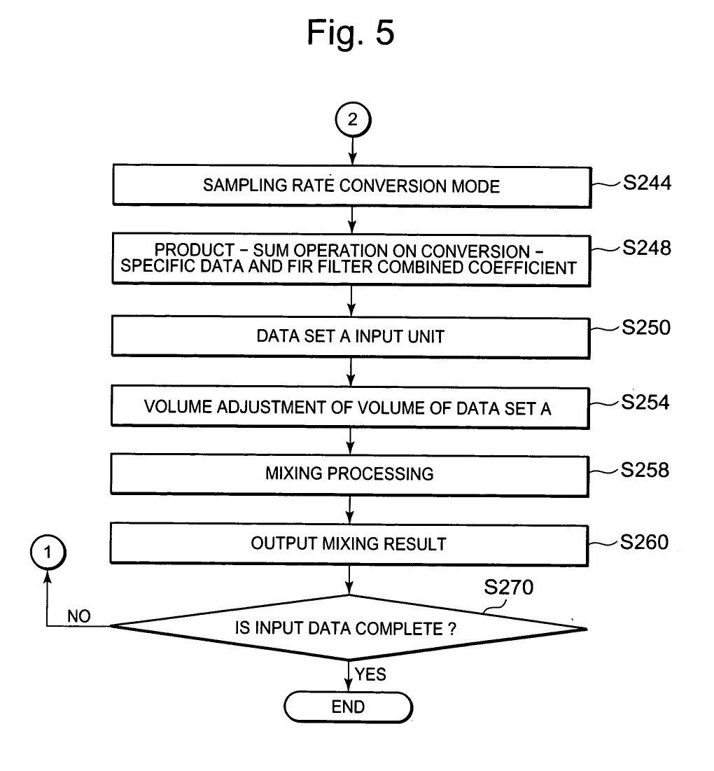

Next, with reference to FIGS. 4 and 5, descriptions will be given of the processing of the mixing device 100 of the present embodiment in a case where the scale factor of the sampling rate is not an integer. To make it easier to understand, as an example, the sampling rates of the data sets A and B are set to 48 KHz and 32 KHz, respectively.

When the scale factor of the sampling rate of the data sets A and B is not an integer, the mixing device 100 upsamples the sampling rate of the digital data B to the integral multiple of the sampling rate of the digital data B and also to the sampling rate of the digital data A and over. Thereafter, the mixing device 100 downsamples the digital data B by outputting the upsampled digital data B to the multiplier 140 while thinning out the upsampled digital data B. In this way, the sampling rate of the digital data B is converted into the sampling rate of the digital data A. In an example of a case where the sampling rate of the digital data A is 48 KHz and the sampling rate of the digital data B is 32 KHz, the sampling rate of the digital data B is upsampled by three times to 96 KHz, and then double downsampling is performed to make it a half. In the following descriptions, the scale factor of upsampling is referred to as an up scale factor, and the scale factor of downsampling is referred to as a down scale factor.

In FIGS. 4 and 5, the same step numbers are given to the similar steps shown in FIG. 3, and new step numbers will be given only to different or additional steps from and to those shown in FIG. 3.

As shown in FIG. 4, upon starting the processing, the processes by the controller 110 from clearing the conversion-specific data buffer 132 to setting the number of times k of data storage to 1 (S200 to S204) is the same as a case where the scale factor of the sampling rate shown in FIG. 3 is an integer. The controller 110 sets, to 0, the counter value (hereinafter, referred to as the output number m) to count the number of outputs of the operation control selector 138 in order to downsample the digital data B (S300).

Then, the controller 110 clears the data register 154 (S210), and causes the conversion-specific data buffer 132 to shift data and to store the data, and increments the number of times k of data storage (S214 to S240). In these processes, a judgment whether to store the sample of the digital data B or 0 in the conversion-specific data buffer 132 in Step 310 is made based on whether or not the number of times k of storage is equal to the up scale factor (S310).

The controller 110 increments the number of times k of storage (S224) as well as increments the data output number m, too (S320). Then, when the data output number m is equal to the down scale factor, the controller 110 resets the data output number m to 0 (S330: Yes), and go to processes shown in FIG. 5. On the other hand, when the data output number m is not equal to the down scale factor, the processing returns to Step S210.

FIG. 5 shows the processes after the data output number m is reset to 0 since the data output number m is equal to the down scale factor in Step S330 of FIG. 4. As shown in FIG. 5, the processes of the controller 110 in this case are the same as the processes after Step S240 (the increment of the number of times k of data storage) in FIG. 3 so that the detailed descriptions will be omitted.

In this manner, when the scale factor of the sampling rate is not an integral multiple, the value 0 is inserted (upsampled) between the samples of the digital data B at the number of times in accordance with the up scale factor. On the other hand, the upsampled data are outputted to the multiplier 140 while being thinned out (downsampled) at a scale factor in accordance with the down scale factor. Hence, even when the scale factor of the sampling rate is not an integral multiple, it is possible to simultaneously perform both the sampling rate conversion and volume adjustment of the digital data B as well as to reduce the processing load of the device since convolution is not performed by the FIR filtering on the thinned samples by downsampling.

### Second Embodiment

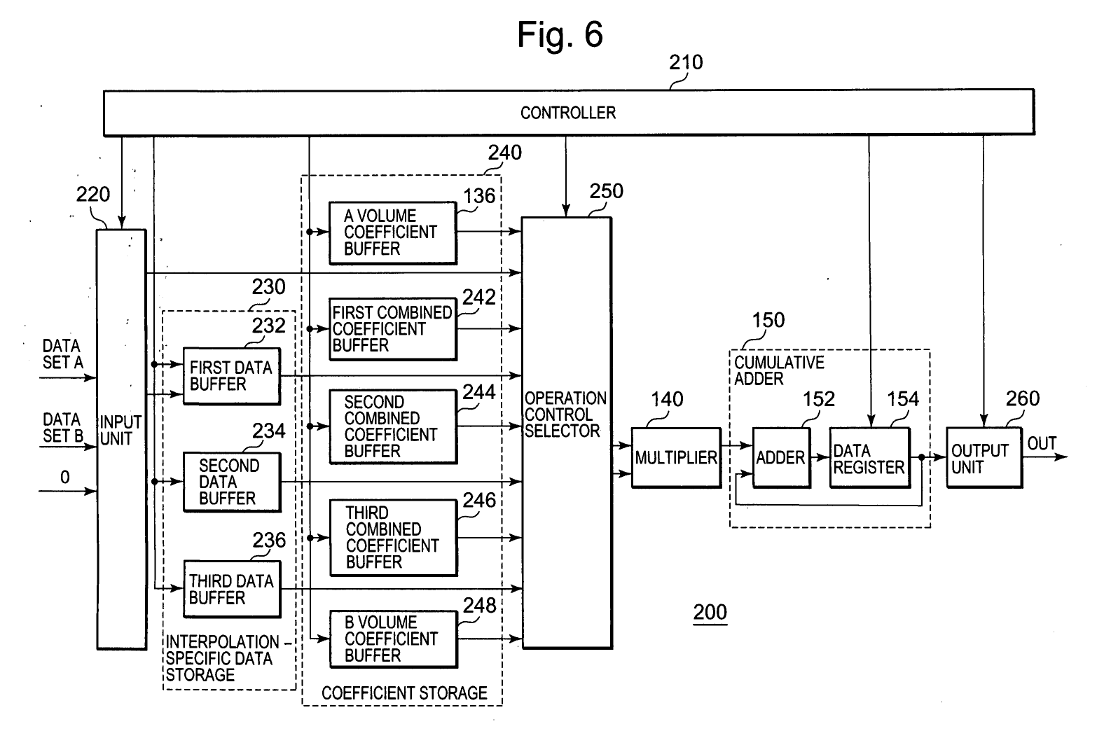

FIG. 6 shows a mixing device 200 according to a second embodiment of the present invention. The mixing device 200, too, is for mixing a plurality of audio data. As an example here, the number of audio data targeted to be processed by the mixing device 200 is two data sets A and B, and the sampling rate of the digital data A is higher than that of the digital data B. In addition, the mixing device 200 is for converting the sampling rate of the digital data B into the sampling rate of the digital data A, and for mixing the digital data A and the digital data B whose sampling rate has been converted. Moreover, upon the sampling rate conversion of the digital data B, the mixing device 200 uses a method for obtaining and inserting interpolation data not by the FIR filtering but by use of three samples as disclosed in Patent Document 1, for example. Note that, in FIG. 6, the same numerical symbols are given to constituents having the same functions as those of the mixing device 100 shown in FIG. 1, and the detailed descriptions will be omitted.

As shown in FIG. 6, the mixing device 200 includes a controller 210, an input unit 220, an interpolation-specific data storage 230, a coefficient storage 240, an operation control selector 250, a multiplier 140, a cumulative adder 150, and an output unit 260.

The interpolation-specific data storage 230 has three buffers: a first data buffer 232, a second data buffer 234, and a third data buffer 236. Each of the three buffers stores a sample, that is, a total of three samples, for obtaining one interpolation data for the digital data B.

The coefficient storage 240 has five coefficient buffers. A A volume coefficient buffer 136 stores a coefficient for the volume adjustment of the digital data A, and a B volume coefficient buffer 248 stores a coefficient for the volume adjustment of the digital data B. A first combined coefficient buffer 242 stores a value (hereinafter, referred to as a first combined coefficient) obtained by multiplying a coefficient, which is to be multiplied by the sample stored in the first data buffer 232 for obtaining the interpolation data of the digital data B, by a coefficient for the volume adjustment of the digital data B. A second combined coefficient buffer 244 stores a value (hereinafter, referred to as a second combined coefficient) obtained by multiplying a coefficient, which is to be multiplied by the sample stored in the second data buffer 234 for obtaining the interpolation data of the digital data B, by a coefficient for the volume adjustment of the digital data B. A third combined coefficient buffer 246 stores a value (hereinafter, referred to as a third combined coefficient) obtained by multiplying a coefficient, which is to be multiplied by the sample stored in the third data buffer 236 for obtaining the interpolation data of the digital data B, by a coefficient for the volume adjustment of the digital data B.

The operation control selector 250 is a selector with nine inputs and two outputs. With regard to samples, from among a total of four data, samples of the digital data A inputted from the input unit 220, a sample stored in the first data buffer 232, a sample stored in the second data buffer 234 (the next sample of the sample stored in the first data buffer 232), and a sample stored in the third data buffer 236 (the next sample of the sample stored in the second data buffer 234), one data set is selected to be outputted to the multiplier 140. With regard to coefficients, from among a total of five coefficients, a A volume coefficient stored in the A volume coefficient buffer 136, a B volume coefficient stored in the B volume coefficient buffer 248, three combined coefficients stored in the three combined coefficient buffers respectively, one coefficient is selected to be outputted to the multiplier 140.

Here, the descriptions of the multiplier 140 and the cumulative adder 150 will be omitted.

The controller 210 is configured of a microprocessor, for example, to control each of the above functional blocks and to set a coefficient in each type of the coefficient buffers. Here, descriptions will be given of the control by the controller 210 over the operation control selector 250 and the output unit 260.

The controller 210 has three control modes: “mixing”, “original sample input,” and “interpolation.” The “interpolation mode” further has tree interpolation steps. The controller 210 causes the operation control selector 250 and the output unit 260 to perform different processes in accordance with the control mode and the interpolation step. “Mixing” is a mode to mix the samples of the data sets A and B; the “original sample input” mode is a mode to output the sample of the digital data B stored in the second data buffer 234; and the “interpolation” mode is a mode to obtain an interpolation sample for the digital data B.

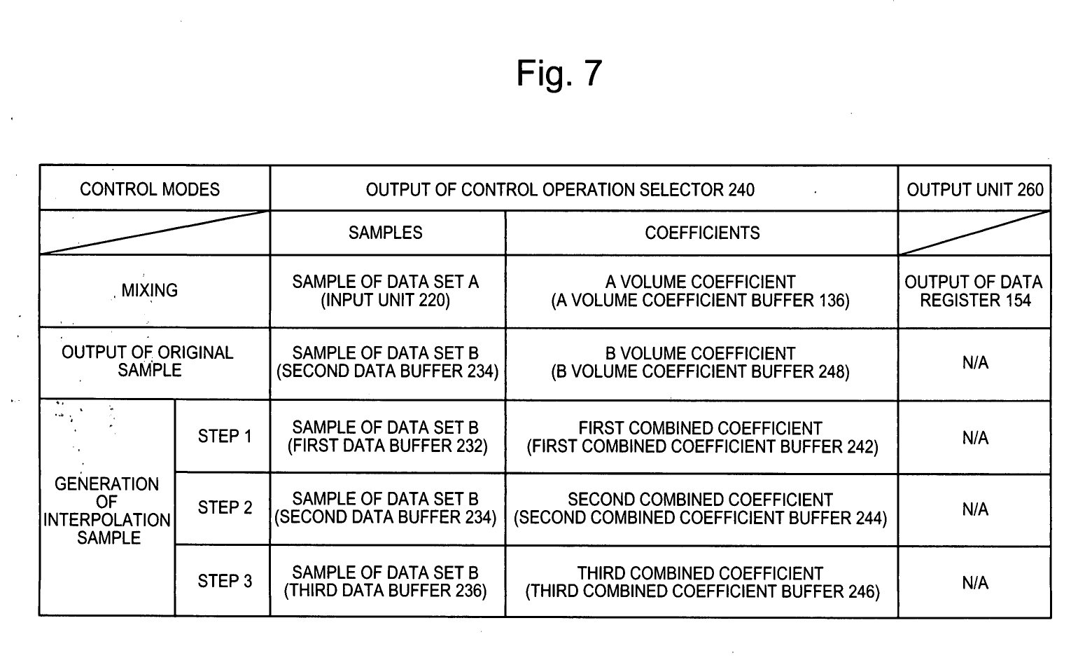

FIG. 7 shows processes performed by the operation control selector 250 and the output unit 260 for each of the three control modes in accordance with the control of the controller 210.

When in the “mixing” mode, the operation control selector 250 outputs the sample of the digital data A inputted from the input unit 220 in terms of the sample, and outputs the A volume coefficient stored in the A volume coefficient buffer 136 in terms of the coefficient. Additionally, in this case, the output unit 260 outputs the data from the data register 154 as the mixed data.

When in the “original sample input” mode, the operation control selector 250 outputs the sample of the digital data B stored in the second data buffer 234 in terms of the sample, and outputs the B volume coefficient stored in the B volume coefficient buffer 248 in terms of the coefficient. Additionally, in this case, the output unit 260 does not output the result of the cumulative operation from the data register 154.

When in the “interpolation” mode, the operation control selector 250 outputs the sample stored in one of the three data buffers of the interpolation-specific data storage 230 and a combined coefficient stored in the combined coefficient buffer corresponding to the one data buffer among the three combined coefficient buffers, in the order corresponding to the interpolation step. Specifically, the sample stored in the first data buffer 232 and the combined coefficient stored in the first combined coefficient buffer 242 are outputted in Step 1, the sample stored in the second data buffer 234 and the combined coefficient stored in the second combined coefficient buffer 244 are outputted in Step 2, and the sample stored in the third data buffer 236 and the combined coefficient stored in the third combined coefficient buffer 246 are outputted in Step 3. Furthermore, the output unit 260 does not output data from the data register 154 in this case, either.

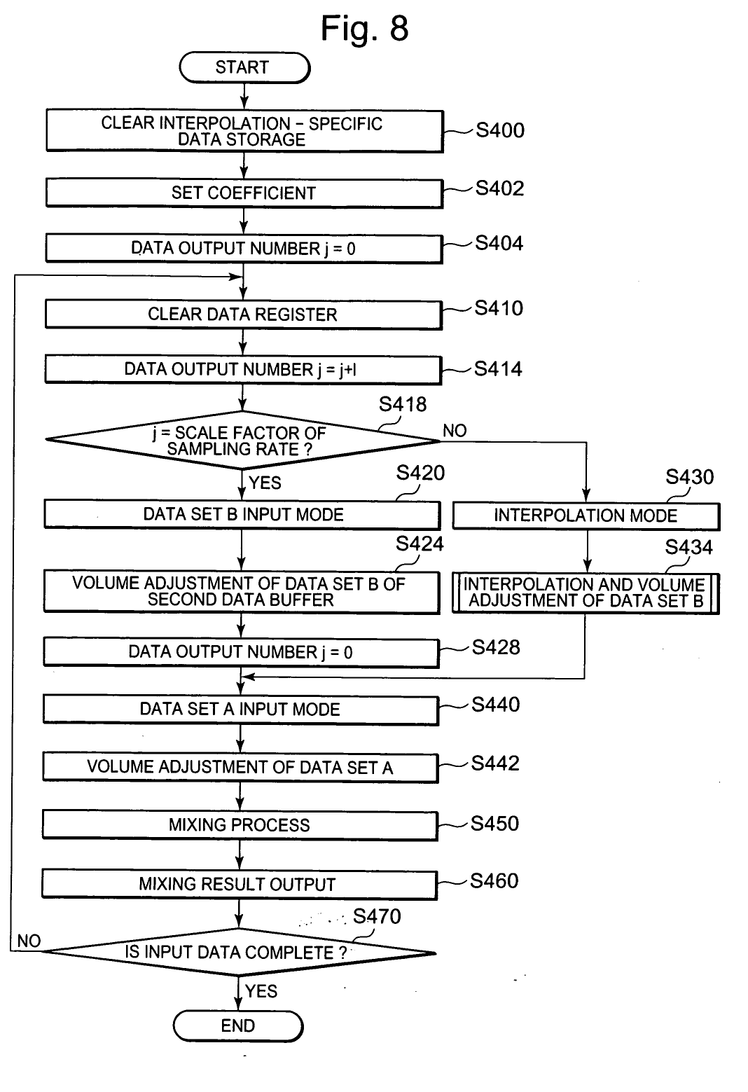

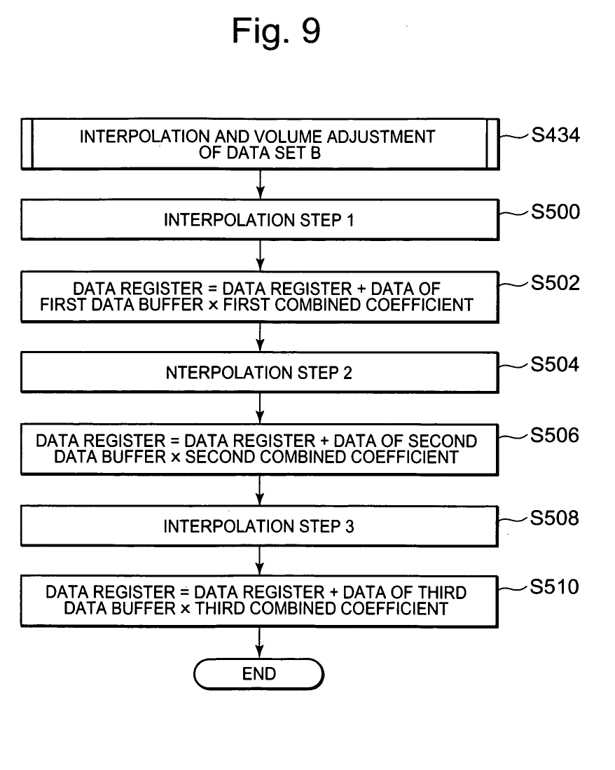

Detailed descriptions will be given of the processing of the mixing device 200. To make it easier to understand, descriptions will firstly be given of a case where the sampling rate of the digital data A is an integral multiple of the sampling rate of the digital data B with reference to FIGS. 8 and 9. As shown in FIG. 8, upon the start of the processing, the controller 210 clears each buffer of the interpolated-specific data storage 230 (S400).

Next, the controller 210 sets a coefficient of each coefficient buffer in the coefficient storage 240 (S402). Specifically, the controller 210 sets the A volume coefficient for the A volume coefficient buffer 136 and the B volume coefficient for the B volume coefficient buffer 248, and sets, for each of the first combined coefficient buffer 242 to the third combined coefficient buffer 246, a value obtained by multiplying each coefficient for the data interpolation by the B volume adjustment coefficient.

Subsequently, the controller 210 sets a data output number j to 0 as well as clears the data register 154 (S410). The data output number j is a counter value to count the number of times that the operation control selector 250 outputs the sample of the digital data B (the data stored in any one of the data buffers of the interpolation-specific data storage 230) to the multiplier 140.

Then, the controller 210 increments the data output number j (S414), and checks whether or not the data output number after the increment is equal to the scale factor of the sampling rate (S418).

Here, when the data output number j is equal to the scale factor of the sampling rate (S418: Yes), the controller 210 controls the “original sample input” mode (S420). In accordance with the control of the controller 210, the operation control selector 250 outputs the data stored in the second data buffer 234 and the B volume coefficient stored in the B volume coefficient buffer 248 to the multiplier 140. Then, the multiplier 140 adjusts the volume of the digital data B by multiplying the data and coefficient from the operation control selector 250, and outputs it to the adder 152 (S420). Then, the controller 210 resets the data output number j to 0 (S428).

On the other hand, when the data output number j is not equal to the scale factor of the sampling rate (S418: No), the controller 210 controls the “interpolation” mode (S430). In accordance with the control of the controller 210, the operation control selector 250 outputs the data and coefficient. As a result, the interpolation of the digital data B and the volume adjustment are performed (S434). Note that, although the details of the process in Step S434 will be described later, the interpolation data to be inserted between the original samples of the digital data B are obtained by this process and are stored in the data register 154.

Next, the controller 210 switches the control mode to “mixing” (S440, S244). With this, the operation control selector 250 outputs the sample of the digital data A inputted from the input unit 220 and the A volume coefficient stored in the A volume coefficient buffer 136. As a result, the multiplier 140 adjusts the volume of the sample of the digital data A by multiplying the sample of the digital data A by the A volume coefficient (S442).

At this point, feedback given from the data register 154 to the adder 152 is a sample value (the sample value or the interpolation data of the digital data B) of the digital data B after the sampling rate conversion. The adder 152 adds the sample value of the digital data A after the volume adjustment to the feedback from the data register 154 so that the data sets A and B are mixed (S450).

Additionally, since the control mode is “mixing”, the output unit 260 outputs the output of the data register 154, that is, the mixing result, to the outside (S460).

The above processes from Step S410 onward are performed until the data inputted to the input unit 220 are complete.

FIG. 9 shows the details of the interpolation and the volume adjustment in Step S434. As illustrated, the controller 210 firstly controls an interpolation step 1 in the control mode (S500). The operation control selector 250 outputs the sample of the digital data B stored in the first data buffer 232 and the first combined coefficient stored in the first combined coefficient buffer 242 in accordance with the control of the controller 210. As a result, the data in the data register 154 is updated to “data stored in the data register 154+data of the first data buffer 232×the first combined coefficient” (S502).

Next, the controller 210 controls an interpolation step 2 in the control mode (S504), and the operation control selector 250 outputs the sample of the digital data B stored in the second data buffer 234 and the second combined coefficient stored in the second combined coefficient buffer 244 in accordance with the control of the controller 210. As a result, the data in the data register 154 is updated to “data stored in the data register 154+data of the second data buffer 234×the second combined coefficient” (S506).

Then, the controller 210 controls an interpolation step 3 in the control mode (S508), the operation control selector 250 outputs the sample of the digital data B stored in the third data buffer 236 and the third combined coefficient stored in the third combined coefficient buffer 246 in accordance with the control of the controller 210. As a result, the data in the data register 154 is updated to “data stored in the data register 154+the third data buffer 236×the third combined coefficient” (S510).

The data value obtained in Step S510 is interpolation data of the digital data B, the volume of which been adjusted. The data value is afterward mixed with the sample of the digital data A, the volume of which has been adjusted, by the processes from Step S440 shown in FIG. 8.

In this manner, according to the mixing device 200 of the present embodiment, when the sampling rate of the digital data B is converted by interpolation, a combined coefficient for interpolation, which is obtained by multiplying a coefficient for interpolation by a coefficient to adjust the volume of the digital data B, is used. Accordingly, both the sampling rate conversion and volume adjustment of the digital data B can be simultaneously performed, and the same effect as that of the mixing device 100 shown in FIG. 1 can be obtained.

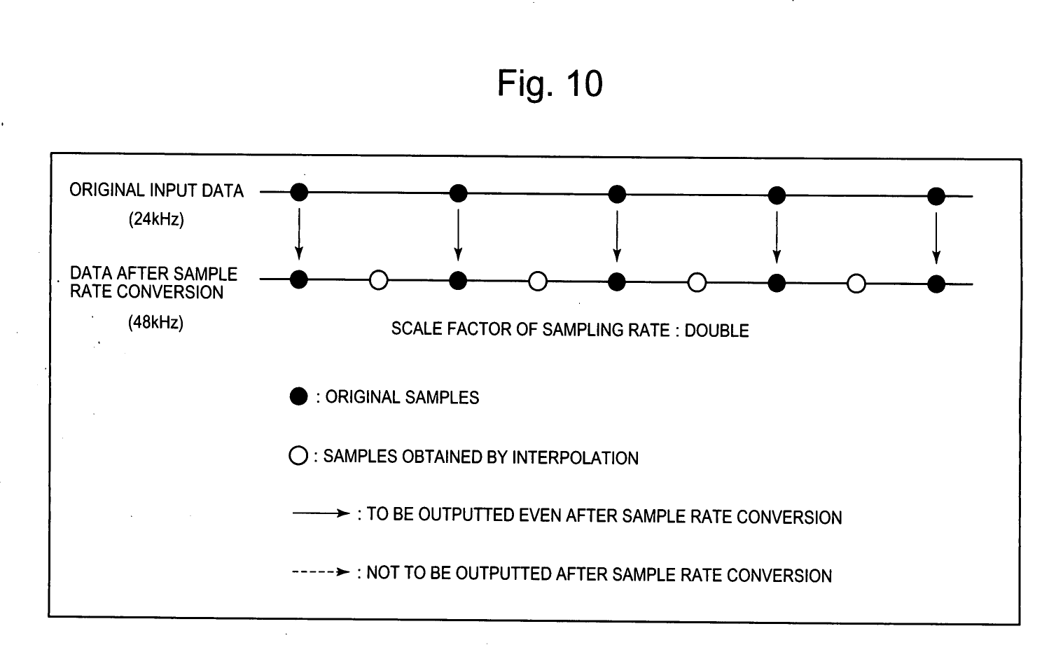

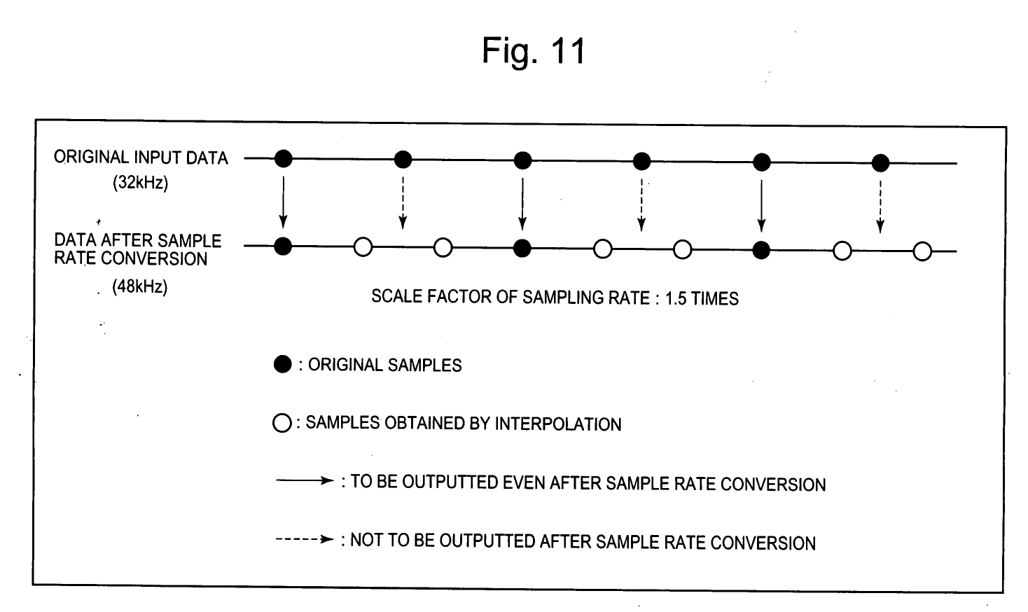

In addition, when the scale factor of the sampling rate of the data sets A and B is not an integer, interpolation data are firstly obtained such that the sampling rate of the digital data B is greater than that of the digital data A as well as is converted to the sampling rate of an integral multiple of the sampling rate of the digital data B. Meanwhile, samples stored in the second data buffer 234 are thinned out to be outputted on condition that the final sampling rate of the digital data B becomes the same as the sampling rate of the digital data A when in the “original sample input” mode. Descriptions will be given of this with reference to FIGS. 10 and 11.

FIG. 10 shows a positional relationship between samples in the original input data (the digital data B) and samples in the digital data B after the sampling rate conversion when the scale factor of the sampling rate of the data sets A and B is an integer (as an example, 2). The black circles in the drawing indicate the original samples of the digital data B, and the white circles are interpolation samples obtained such that the sampling rate of the digital data B is converted to make it double. As illustrated, in this case, all the original samples of the digital data B exist in data after the sampling rate conversion.

FIG. 11 shows a positional relationship between samples in the digital data B and samples in the digital data B after the sampling rate conversion when the scale factor of the sampling rate of the data sets A and B is not an integer, and is 1.5 as an example here. As illustrated, the original samples of the digital data B exist in the data after the sampling rate conversion while one sample is thinned out in every two samples. This results in the 1.5-times sampling rate of the digital data B. With regard to a specific method for implementing this, the same method as the one used in the mixing device 100 is sufficient, and the detailed descriptions will be omitted here.

In this manner, the mixing device 200 of the present embodiment can perform the mixing with a small circuit size and a small operation load, even when the scale factor of the sampling rate of a plurality of digital audio data is not an integer, like the mixing device 100.

Hereinbefore, the descriptions have been given of the present invention based on the embodiments. The embodiments are mere illustrations, and various amendments and increase/decrease can be added as long as they do not depart from the spirit of the present invention. It is understood by those skilled in the art that modification examples to which these amendments and increase/decrease are added are also within the scope of the present invention.

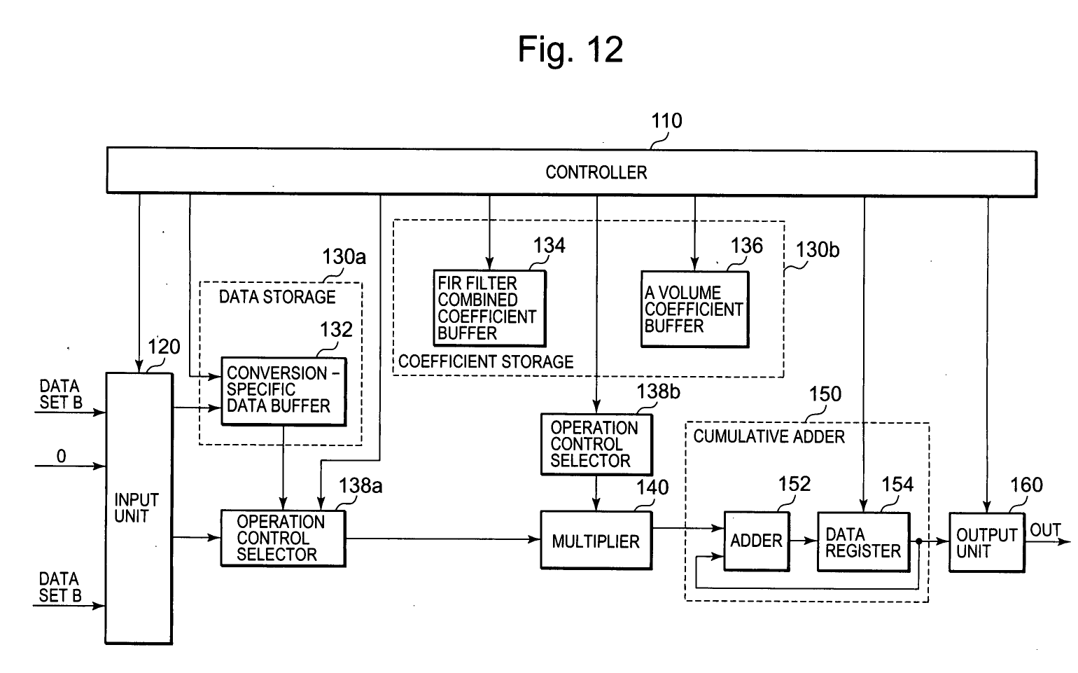

For example, in the mixing device 100, a sample and a coefficient to be outputted to the multiplier 140 is selected by the operation control selector 138. For example, as shown in FIG. 12, two operation control selectors 138a and 138b may be used instead of the operation control selector 138. The operation control selector 138a may select a sample, and the operation control selector 138b may select a coefficient. This is the case to the mixing device 200, too.

Moreover, for example, the mixing device 200 obtains an interpolation sample by use of, as an example, the three original samples of the digital data B when converting the sampling rate of the digital data B. If an operation to obtain the interpolation sample is the product-sum operation for the plurality of original samples and interpolation coefficients corresponding to the respective samples, it is possible to apply the present invention, and the number of original samples to be used when obtaining the interpolation sample is not limited to three.

Furthermore, the mixing devices 100 and 200 are for mixing two audio data, but the technology of the present invention can be applied to a device mixing an arbitrary number of three audio data or more.

In addition, the technology of the present invention can be applied to the mixing processing for not only audio data but also any kind of data which require the volume adjustment upon mixing.

Further, it is noted that, Applicant's intent is to encompass equivalents of all claim elements, even if amended later during prosecution.

What is claimed is:

1. A mixing device for mixing a digital data A having a first sampling rate and a digital data B having a second sampling rate which is lower than the first sampling rate, comprising:
a data storage which stores, while shifting, a plurality of newest samples in the digital data B and insertion values of a number according to a ratio of the first and second sampling rates, as the samples for conversion, the insertion values being inserted between the plurality of samples in response to an insertion signal;
a coefficient storage which stores a plurality of combined coefficients obtained by multiplying each of a plurality of conversion coefficients by a B volume coefficient for adjusting a volume of the digital data B, the plurality of conversion coefficients being for obtaining samples in the digital data B by a product-sum operation with the plurality of samples for conversion stored in the data storage after the sampling rate is converted to the first sampling rate;
an operation control selector which outputs a sample/coefficient pair comprising one sample for conversion among the plurality of samples for conversion stored in the data storage and one combined coefficient, which corresponds to the sample for conversion among the plurality of combined coefficients stored in the coefficient storage, and which performs a first output process to sequentially output the sample/coefficient pairs of a number according to a degree of the product-sum operation;
a multiplier which multiplies each sample/coefficient pair outputted from the operation control selector;
a cumulative adder which cumulates a multiplication result of the multiplier; and
a controller which generates the insertion signal which is provided to the data storage.

2. The mixing device according to claim 1, wherein the conversion coefficient comprises an FIR (Finite Impulse Response) filter coefficient.

3. The mixing device according to claim 2, wherein the insertion value is a value 0.

4. The mixing device according to claim 1, further comprising a mixing result output unit which outputs the result of the cumulative adder to the outside, wherein:
the coefficient storage further stores an A volume coefficient for adjusting a volume of the digital data A,
the operation control selector performs the first output process when a control signal shows “the conversion of a sampling rate,” and performs a second output process of outputting a sample/coefficient pair comprising a newest sample in the digital data A and the A volume coefficient stored in the coefficient storage when the control signal shows “mixing,”
the controller generates the control signal showing the “conversion of a sampling rate” and the “mixing” and provides the control signal alternately to the operation control selector and to the mixing result output unit, and
the mixing result output unit outputs the result of the cumulative adder on condition that the control signal shows the “mixing.”

5. The mixing device according to claim 4, wherein when the ratio of the first sampling rate and the second sampling rate is not an integer,
each combined coefficient stored in the coefficient storage is set so that the sampling rate of the digital data B is converted to a middle sampling rate which is an integral multiple of the second sampling rate and is greater than the first sampling rate, and
the controller generates the insertion signal such that the insertion values of a number, according to the middle sampling rate and the second sampling rate, are inserted, as well as reduces the number of times to provide the control signal showing “the conversion of a sampling rate” to the operation control selector such that the frequency of the first process being performed agrees with the first sampling rate.

6. A mixing device for mixing a digital data A having a first sampling rate and a digital data B having a second sampling rate which is lower than the first sampling rate, comprising:
a data storage which stores, while shifting, a plurality of newest samples in the digital data B;
a coefficient storage which stores a plurality of combined coefficients and a B volume coefficient for adjusting a volume of the digital data B, the plurality of combined coefficients being obtained by multiplying the B volume coefficient by a plurality of interpolation coefficients which are determined in accordance with a ratio of the first sampling rate and the second sampling rate, the plurality of interpolation coefficients being for obtaining interpolation samples designed to be inserted between the plurality of samples to convert the sampling rate of the digital data B to the first sampling rate by performing a product-sum operation on the plurality of interpolation coefficients and the plurality of samples stored in the data storage;
an operation control selector which performs a first output process of outputting a specified sample among the plurality of samples stored in the data storage and a B volume coefficient stored in the coefficient storage when a control signal shows “an output of an original sample,” while performing a second output process of sequentially outputting one sample after another from among the plurality of samples together with one combined coefficient, which corresponds to the one sample, among the plurality of combined coefficients stored in the coefficient storage when the control signal shows “a generation of an interpolation sample”;
a multiplier which multiplies the sample/coefficient pair outputted from the operation control selector;
a cumulative adder which cumulates a multiplication result of the multiplier; and
a controller which generates the insertion signal which is provided to the data storage.

7. The mixing device according to claim 6, further comprising a mixing result output unit which outputs a result of the cumulative adder to the outside, wherein:
the coefficient storage further stores an A volume coefficient for adjusting a volume of the digital data A,
the operation control selector performs a third output process of outputting a newest sample in the digital data A and the A volume coefficient stored in the coefficient storage when the control signal shows “mixing,”
whenever the control signals of “the output of an original sample” and “the generation of an interpolation sample” are given to the operation control selector, the controller generates the control signal showing “mixing” following the given control signal and provides the control signal to the operation control selector and to the mixing result output unit, and
the mixing result output unit outputs the result of the cumulative adder on condition that the control signal shows “mixing.”

8. The mixing device according to claim 7, wherein when the ratio of the first sampling rate and the second sampling rate is not an integer,
the combined coefficient stored in the coefficient storage is set so that the sampling rate of the digital data B is converted to a middle sampling rate which is an integral multiple of the second sampling rate and is greater than the first sampling rate, and
the controller reduces the number of times that the control signal showing “the output of an original sample” is provided to the operation control selector such that the sum of the frequency of the first output process being performed and the frequency of the second output process being performed agrees with the first sampling rate.

9. A method of mixing a first digital data having a first sampling rate and a second digital data having a second sampling rate, comprising:
converting said second digital data, by using a first coefficient obtained by multiplying a sampling coefficient with a volume coefficient for said second digital data, to produce a converted second digital data which has a same sampling rate as said first digital data;
converting said first digital data, by using a volume coefficient for said first digital data, to produce a converted first digital data; and
mixing said converted second digital with said converted first digital data.

10. The method as claimed in claim 9, wherein said sampling coefficient comprises an FIR (Finite Impulse Response) filter coefficient.

11. The method as claimed in claim 9, wherein said second digital data is converted by
storing said second digital data into a first buffer;
storing said first coefficient into a second buffer;
multiplying the second digital data in said first buffer and the first coefficient to produce said converted second digital data; and
storing said converted second digital data into a data register.

12. The method as claimed in claim 11, wherein said first digital data is converted by
storing said first digital data into said first buffer;
storing said volume coefficient for said first digital data into a third buffer; and
multiplying the first digital data in said first buffer and the volume coefficient for said first digital data to produce said converted first digital data.

13. The method as claimed in claim 12, wherein said mixing is performed by adding said converted first digital data with said converted second digital data in said data register.

14. The method as claimed in claim 9, wherein said sampling coefficient comprises an interpolation coefficient which is determined in accordance with a ratio of the first sampling rate and the second sampling rate.

15. The method as claimed in claim 14, wherein said second digital data is converted by
storing a volume coefficient of said second digital data into a first buffer;
storing said interpolation coefficient into a second buffer; and
calculating by using said second digital data, an interpolation data of said second digital data and said interpolation coefficient

16. The method as claimed in claim 11, wherein said first digital data is converted by multiplying the first digital data and the volume coefficient for said first digital data, to produce said converted first digital data.
